(19) United States
(12) Patent Application Publication
(10) Pub. No.: US 2006/0208150 A1
(43) Pub. Date: Sep. 21, 2006

(54) Track clamping holder for fixing tracks of sliding door systems

(76) Inventors: Hubert Elmer, Innsbruck (AT); Michael Beck, Neu Rum (AT); Herbert Volderaver, Fulpmes (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/554,429

(22) PCT Filed: Oct. 27, 2004
(86) PCT No.: PCT/EP04/12130

§ 371 Date: Oct. 24, 2005

(30) Foreign Application Priority Data
Oct. 28, 2003 (DE) 103 50 414.1

(51) Int. Cl. A47G 29/00; E05D 15/06

(52) U.S. Cl. 248/694; 49/409; 52/207

(57) ABSTRACT

A runner rail clamping holder for receiving a runner rail in a runner rail receptacle has a wall and a connection plate mounted to the wall. The wall has a recess for receiving a clamping member arranged in the wall and in the connection plate. The clamping member is rotatably supported in the recess and can be clamped between the runner rail and a substrate structure by a screw.

The invention is directed to a runner rail clamping holder for fastening runner rails for sliding door systems according to the preamble of patent claim 1.

The runner rail clamping holders perform a dual function. On one hand, they serve to fix the runner rail, which generally has a circular cross section, to the runner rail clamping holder. On the other hand, the runner rail clamping holder serves as connection to a substrate structure that can comprise, for example, a counterplate which can likewise be fastened in a clamping manner to the runner rail clamping holder and which, in turn, can be connected by frictional engagement to other parts of the substrate structure. By “substrate structure” is meant not only the possible connection to a stationary structural component part, e.g., masonry or a metal structure, but also, for example, the glass pane of a sliding door.

DE 100 35 956 C2 discloses a runner rail clamping holder in which the clamping device comprising the runner rail with the runner rail receptacle of the runner rail clamping holder comprises a runner rail clamp that can be tightened against the surface of the runner rail by means of a runner rail locking screw by reducing the diameter of the runner rail receptacle. A second locking screw is required for the clamping connection between the runner rail clamping holder and the substrate structure, the latter comprising a counterplate that is guided so as to be displaceable in a groove of a connection plate of the runner rail clamping holder. To this extent, reference is had to the disclosure of DE 100 35 956 C2.

DE 101 39 167 C1 discloses a further development that is an improvement over DE 100 35 956 C2 insofar as the runner rail clamping holder can be clamped in a frictional engagement with the runner rail and with the substrate structure by means of an individual clamping device. This is carried out by means of an individual grub screw which penetrates the wall of the runner rail clamping holder coaxial to the longitudinal axis of the runner rail and which can be adjusted against an end face of the clamping member. The grub screw acts on an expansion member comprising two wedges which are displaceable relative to one another so that the diameter of the runner rail receptacle is likewise changed. However, use of the above-mentioned wedges entails the risk that the wedges cannot be disengaged from one another because of self-locking, so that the connection cannot be loosened dependably.

Proceeding from the prior art according to DE 101 39 167 C1, it is the object of the invention to improve the runner rail clamping holder mentioned above with respect to the construction of the clamping member.

This object is met by the invention through the features according to claim 1.

Further characteristic features are indicated in the subclaims.

According to the invention, a clamping member which is formed as a disk and which is supported with slight play in a circular recess of the runner rail clamping holder is rotated in the recess by means of a screw. A surface of the disk facing the runner rail is constructed in such a way that the disk enters the area of the runner rail receptacle with parts of the above-mentioned surface when rotating, i.e., the disk reduces the diameter of the runner rail receptacle in a known manner and accordingly contacts the surface of the runner rail. The plane surface of the disk remote of the runner rail is supported at the substrate structure which, as is disclosed, e.g., in DE 100 35 956 C2, can comprises a counterplate that is displaceably guided with play in a groove of the connection plate.

Since the counterplate that is guided in the groove of the connection plate has a plane surface, the disk is constructed in such a way that the surface facing the substrate structure is likewise a plane surface, so that when the plane surface of the counterplate and the plane surface of the disk contact one another the play in the groove is eliminated and the counterplate is clamped with the connection plate of the runner rail clamping holder. The surface of the disk facing the runner rail advantageously has, at least in the area of a segment of the surface, a concave curvature which complements the surface curvature of the runner rail and which is constructed in such a way that the disk contacts the runner rail in a corresponding manner when the connection is disengaged.

The disk is advantageously constructed in such a way that it has, e.g., two concave curvatures. The surface of the disk facing the runner rail has, in the area of two segments, a concave curvature that complements the surface curvature of the runner rail such that the curvature of one segment complements the surface curvature of the runner rail when the clamping member is loosened and the curvature of the other segment complements the surface curvature of the runner rail when the clamping member is tightened. In practice, this means that as a result of the concave curvature arranged in the first segment the disk contacts the runner rail in such a way when the connection is loosened it does not rotate automatically even though a displacement of the runner rail in the runner rail clamping holder is possible and a displacement of the counterplate relative to the connection plate of the runner rail clamping holder is possible. On the other hand, during the clamping process, there is temporarily a line contact between the disk and the runner rail which changes to a surface area contact due to the arrangement of the second curvature in the second segment of the surface of the disk in the clamped position.

In another advantageous construction of the invention, the disk is constructed in such a way that it has a cutout and an end face of the cutout is formed by an adjusting protuberance defining the cutout. The screw that causes the rotating movement can be tightened against this adjusting protuberance which is preferably an integral part of the disk. The adjusting protuberance has a shoulder that is directed toward the runner rail for purposes of reinforcement in this area.

Due to the above-described concave curvatures of the surface of the disk facing the runner rail and the reduction in the diameter of the runner rail receptacle aimed for by the rotating movement of the disk, the width of the outer surface of the disk changes along the circumference of the disk, whose widest surface is located at the side opposite to the adjusting protuberance. This feature refers to the construction of the disk in cooperation with a runner rail having a circular cross section; when using a runner rail with a cross section of a different shape, the surface of the disk facing the runner rail must be adapted in a corresponding manner.

The disk forming the clamping member can be made from any suitable material in principle; however, a suitable metal is preferably used, i.e., the disk can be formed from a cast piece, a hardened forged piece, or the like.

The invention will be described more fully in the following with reference to an embodiment example.

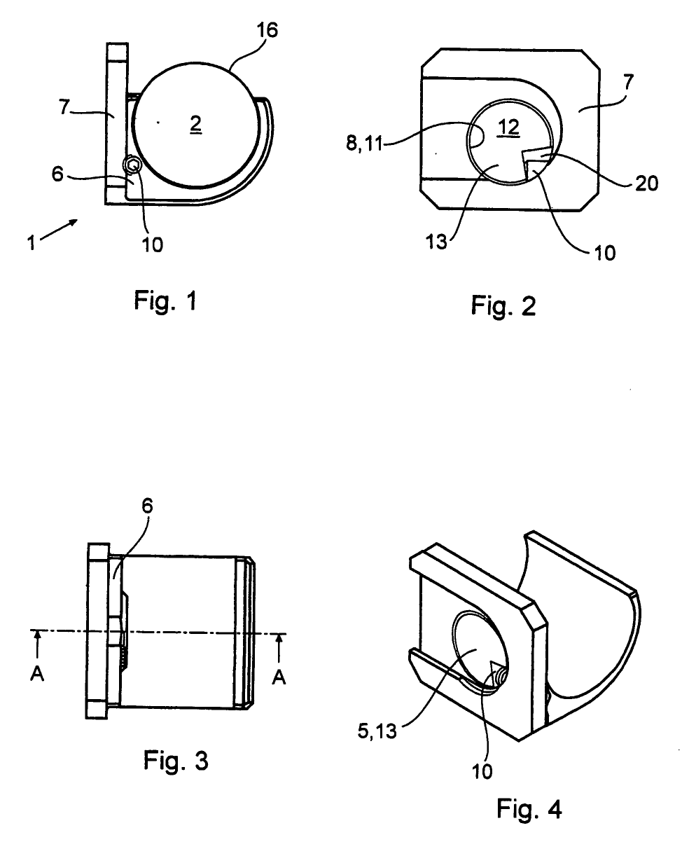

FIG. 1 shows a side view of a runner rail clamping holder;

FIG. 2 shows a side view referring to FIG. 1;

FIG. 3 shows a top view of the runner rail clamping holder without the runner rail;

FIG. 4 shows a perspective side view referring to FIG. 3;

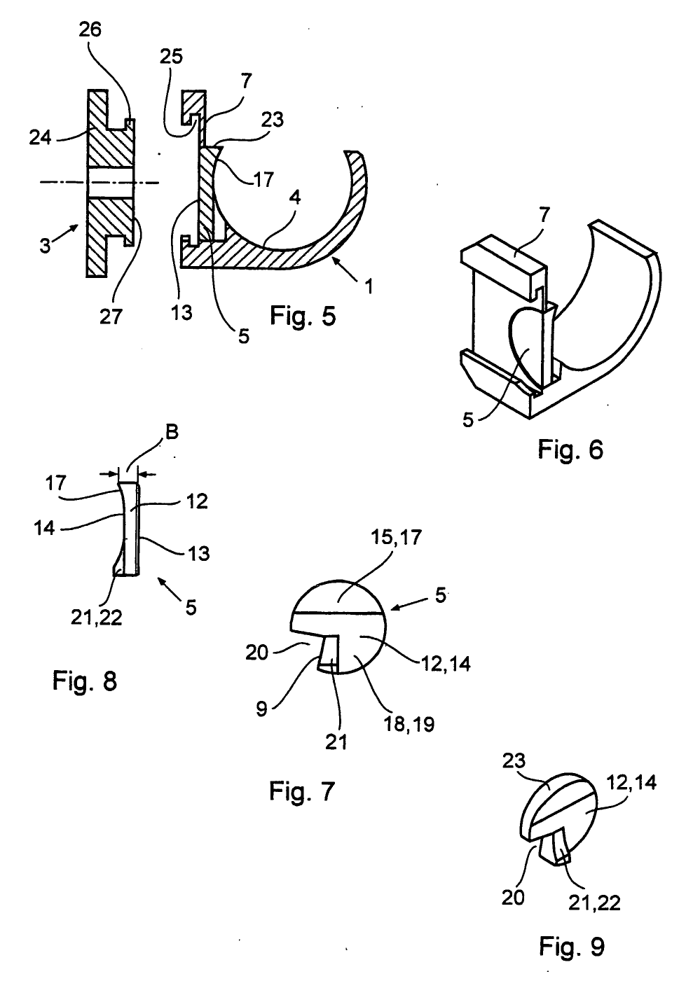

FIG. 5 shows section A-A referring to FIG. 3, including a counterplate;

FIG. 6 is a perspective section through the runner rail clamping holder according to FIG. 5;

FIG. 7 is a view of the clamping member;

FIG. 8 is a side view referring to FIG. 7; and

FIG. 9 is a perspective view of the clamping member.

A runner rail clamping holder 1 engages around a runner rail 2 by more than half of the diameter of the runner rail 2 with its runner rail receptacle 4. A connection plate 7 is formed integral with a wall 6 of the runner rail clamping holder 1. The connection plate 7 has grooves 25 in which a flange 26 of a counterplate 24 engages, this counterplate 24 forming a substrate structure 3. A clamping member 5 which is constructed as a disk 12 is rotatably supported in an opening 8 (see FIG. 2) which penetrates the wall 6 of the runner rail clamping holder 1 and the connection plate 7 and which forms a recess 11. The circular disk 12 has a cutout 20 so that an end face 9 in the form of an adjusting protuberance 21 is formed at the disk 12. A screw 10 which penetrates the wall of the runner rail clamping holder 1 coaxial to the longitudinal axis of the runner rail 2 can be tightened against the adjusting protuberance 21. The adjusting protuberance 21 itself has a shoulder 22 that widens in direction of the runner rail 2.

The surface 13 of the disk 12 that faces the substrate structure 3, i.e., in the embodiment example, a plane surface 27 of the flange 26 of the counterplate 24, is likewise constructed as a plane surface. In the embodiment example, an opposite surface 14 of the disk 12 that faces the surface curvature 16 of the runner rail 2 has, in the area of a segment 15 located opposite to the adjusting protuberance 21, a concave curvature 17 that is adapted to the surface curvature 16 of the runner rail 2 and, in addition, in the area of a second segment 18, another concave curvature 19 that is adapted to the surface curvature 16 of the runner rail 2. The two curvatures of the surface 14 of the disk 12 are adapted to one another in such a way that the first curvature 17 of the surface 14 of the disk 12 contacts the surface curvature 16 of the runner rail 2 when the connection is loosened and the second curvature 19 contacts the surface curvature 16 of the runner rail 2 when the clamping member 5 is tightened. As a result of the shape of the above-mentioned concave curvatures in the area of the surface 14 of the disk 12, there is a change in an outer surface 23 of the disk 12 along the circumference of the disk 12. As can be seen in FIGS. 8 and 9, the outer surface 23 of the disk 12 has the greatest width B in the area located opposite to the adjusting protuberance 21.

### REFERENCE NUMBERS

1 runner rail clamping holder
2 runner rail
3 substrate structure
4 runner rail receptacle
5 clamping member
6 wall of the runner rail clamping holder
7 connection plate
8 opening
9 end face of the clamping member
10 screw
11 recess
12 disk
13 surface
14 surface
15 segment
16 surface curvature
17 curvature of the surface of the disk
18 segment
19 curvature of the surface of the disk
20 cutout
21 adjusting protuberance
22 shoulder
23 outer surface
24 counterplate
25 grooves
26 flange
27 plane surface
B width

1-10. (canceled)

11. A runner rail holder for fastening a runner rail of a sliding door to a substrate structure, the runner rail holder comprising:
a receptacle configured to grasp the runner rail in a channel, the receptacle having an opening extending therethrough perpendicular to the channel;
a clamping member rotatably mounted in the opening and having an end face, the end face forming a portion of a wall of the channel, the clamping member being configured so that when the clamping member is rotated in the opening of the receptacle, the end face of the clamping member frictionally tightens the runner rail in the channel of the receptacle; and
a screw rotatably mounted in the receptacle so that rotation of the screw causes an end of the screw to engage the clamping member to cause the clamping member and the end face thereof to rotate.

12. The runner rail holder of claim 11, wherein the opening is circular and the clamping member is a disk.

13. The runner rail holder of claim 11, wherein the end face of the clamping member has a concave portion shaped to complement a surface curvature of the runner rail.

14. The runner rail holder of claim 11, wherein the end face of the clamping member has a first concave portion shaped to complement a surface curvature of the runner rail when the clamping member is tightened, and a second concave portion shaped to complement a surface curvature of the runner rail when the clamping member is not tightened.

15. The runner rail holder of claim 12, wherein the disk has a cutout with which the screw engages.

16. The runner rail holder of claim 15, wherein the disk has a protuberance adjacent the cutout, the protuberance being integrally formed with the disk.

17. The runner rail holder of claim 16, wherein the protuberance extends towards the runner rail.

18. The runner rail holder of claim 17, wherein a width of the disk at a circumference thereof varies so that the width is the greatest substantially diametrically opposite the protuberance.

19. The runner rail holder of claim 11, further comprising a counterplate connectable to a surface of the receptacle, the counterplate being configured for attachment thereof to the substrate structure.

20. The runner rail holder of claim 12, wherein the disk is comprised of metal.
